(19) United States
(12) Patent Application Publication
(10) Pub. No.: US 2009/0180392 A1
(43) Pub. Date: Jul. 16, 2009

(54) Radio-Transmission System and Corresponding Method of Operation

(75) Inventors: Guenter Greiner, Muenchen (DE); Rainer Bott, Andechs (DE)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: Rohde & Schwarz GmbH & Co. KG, Munchen (DE)

(21) Appl. No.: 12/299,722

(22) PCT Filed: Apr. 10, 2007
(86) PCT No.: PCT/EP07/03183

§ 371 Date: Nov. 5, 2008

(30) Foreign Application Priority Data
May 10, 2006 (DE) 10 2006 021 831.0

(51) Int. Cl. H04L 12/26

(52) U.S. Cl. 370/252

(57) ABSTRACT

A radio transmission system has an ad-hoc network, which can be used to transmit data packets with a prescribed waveform, for each node a rating device, which rates the quality of the transmission of the data packets via the ad-hoc network, and an orientation channel. The orientation channel is used to transmit the data packets when the rating device has rated the quality of the transmission of the data packets via the ad-hoc network as unsatisfactory.

The invention relates to a radio-transmission system and a corresponding method of operation.

Modern radio-network concepts, such as network-centric warfare concepts, provide information in an appropriate form and without time delay wherever this information is required. Communications system suitable for this purpose are already the subject of intensive developmental work. Stringent requirements are placed on such systems, including, for example, good mobility, maximum-possible inter-operability (for example, also with civilian authorities (BOS)), transparency of the networks (wire-bound/wireless, PSTN, ISDN, LAN, WAN/radio/directional radio network, military/civilian), universal availability, information transmission in conjunction with reconnaissance/guidance/effect, position report, position display, friend-foe identification, sensor data, images from digital cameras, GPS tracking, e-mail, short messages, other IP services, ad-hoc mobile networking (MANET) and independence from an infrastructure.

The type of communication from highly-mobile network participants, such as tactical troops, is increasingly subject to change. The application “secure speech connection”, that is to say, speech coded and resistant to potential interference sources, was formerly the almost exclusive priority.

Nowadays, alongside the requirements of telephony, there is an increasing requirement for a networking of different communication participants with personal availability. This type of networking requires inter-operability of the communications technologies and integration of networks to form combined systems.

For reasons of inter-operability, the use of Internet protocols, e.g. TCP/IP, is required for networking data communication beyond the various networks. The radio technology can be realized in a narrow band, for example, with reference to the standard 1.5 MIL-STD-188-220 B. This standard specifies the lower protocol levels for an inter-operability of tactical radio devices.

Tactical radio is currently based on channels with 25 kHz bandwidth, across which a total of 16 kbit/s can generally be transmitted with FEC up to 9.6 kbit/s. The use of standard Internet protocols for the realisation of ad-hoc mobile networking (MANET) in military radio communications would provide a rapid and cost-favorable solution. However, this requires data rates in the range of Mbit/s and accordingly bandwidths in the MHz range. They cannot therefore be used in radio channels limited to a bandwidth of only 25 kHz. Radio devices with this bandwidth have so far not been used in the tactical field up to the company level.

Radio devices with fast data rates and therefore broad signal bandwidths are subject to the following restrictions with regard to the propagation of the radio signals along the surface of the earth (that is to say without free-space propagation as in the case of airborne platforms): for an effective use, a relatively-higher frequency range (225 MHz to 400 MHz, but also up to 2 GHz or above is advisable). However, the range of radio signals declines with an increasing frequency. Increasing the transmission power increases this range only to a moderate extent. An eight-fold transmission power only doubles the range.

The required bandwidth is proportional to the desired data rate. However, the range falls within increasing bandwidth. As a result, with an increase in the data rate from 16 kbit/s to 1.6 Mbit/s, the range declines by a factor of approximately 5. Since broad bandwidths generally necessitate relatively-higher transmission frequencies—because, for example, the tactical frequency range from 30 MHz to 88 MHz can no longer be used because of the broad bandwidth and density of occupation—further sacrifices with regard to range must be taken into consideration.

Higher-value modulation types require a relatively-higher signal-noise ratio and therefore achieve a reduced range with the same transmission power by comparison with the use of relatively-simpler modulation methods.

The number of radio devices necessary to provide radio cover depends very heavily upon the range. This in turn is dependent upon the frequency range, the necessary signal-noise ratio, the data rate or respectively signal bandwidth and the transmission power.

Documents DE 196 51 593 A1 and DE 198 07 931 A1 relate to an optimisation of these parameters.

Broadband radio devices for fast data rates are certainly the ideal solution for networked communication. However, their radio range is limited. Radio devices with 25 kHz channels are characterized by medium data rates, long ranges and robust modulation methods. For this reason, they are indispensable for tactical use. Additionally, for secure radio telephony, they can be incorporated in current and future data networks with IP-supporting protocols such as the MIL-STD-188-220 B.

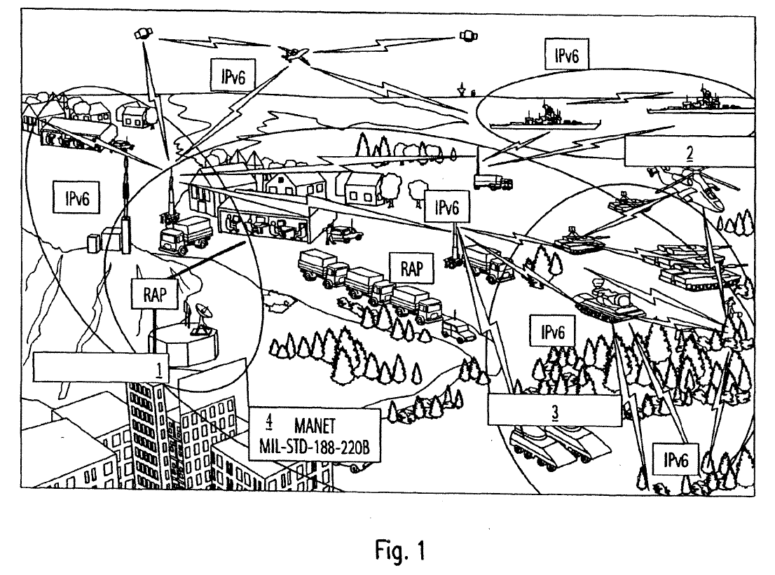

Self-orginizing networks with automatic routing, which can support applications based on the Internet protocol IP, can be realized with the MIL-STD-188-220 B standard. Accordingly, the traditional tactical radio can be expanded for the digital battlefield network, as illustrated in FIG. 1.

The combined hardware/software system 1 guarantees modern Internet/intranet communication via different transmission media. The Signal Management & Control System 2 automates radio communication on ships, while the Signal Management & Control System 3 organises radio communication for land-based units. All systems 1 to 3 are incorporated in the MANET ad-hoc network 4.

Wire-bound networks and (quasi-stationary) radio networks with fast data rates, such as directional radio networks differ considerably in their properties from mobile tactical radio networks. Traditionally-used tactical radio devices currently provide data rates up to a maximum of 16 kbit/s. Up to 72 kbit/s are supported by the recently-marketed generation of radio devices.

Radio devices for tactical radio with data rates in the order of magnitude of Mbit/s are currently under development. Commercial solutions, such as WLAN provide a satisfactory solution only in exceptional cases, because they operate exclusively at a predetermined frequency. The substantial disadvantage of this solution is that it is not protected, for example, against targeted interference. Further disadvantages of a single-channel system are avoided in future, modern broadband radio devices by the properties described below, such as adapting the waveform to the varying channel quality.

Conventionally, and also within the framework of the present application, “waveform” is the term used for the radio signal in the air; alongside the modulation type, data rate and optionally the frequency-hop sequence or spreading code, it also contains, for example, coding and encryption, and, in the case of modern methods, also protocols.

In mobile use, the quality and therefore the capacity of the radio channels depends upon the topology, the properties of the terrain and the distances to be bridged.

This means that the available channel capacity can vary between the maximum data rate of a broadband radio device of, for example, 2 Mbit/s and that of a narrow-band radio device of a few kbit/s. Furthermore, the properties of the radio channels are characterized by physical marginal conditions, such as: attenuation, reflection, refraction, diffraction and Doppler shift.

These lead to reception interference, multi-path propagation, frequency-selective and time-variant fading. The property of the radio connection affected by the latter is substantially the signal quality, which is described by the signal-noise ratio, the signal distortion and signal jitter caused by the channel and, derived from the latter, the channel capacity (data rate/bandwidth), the bit-error rate (BER) and the range.

In given circumstances of use, especially with relatively-large distances between radio nodes, the radio networks can provide so-called bottlenecks. In order to achieve a satisfactory exploitation of the networks in spite of these temporary, potential restrictions on channel capacity and quality resulting from the mobility of the radio networks and their physical properties, several measures needs to be investigated and realized in future networks.

As disclosed in the not-previously-published document DE 10 2005 030 108 A1, modern radio-transmission systems are conceived in such manner that they can respond adaptively to changing scenarios of extremely varied character. For example, scenarios can be anticipated, which provide a relatively-high density of mutually-communicating radio devices at short distances. For homogenous radio networks of this kind, adapted mobile ad-hoc networks with appropriate routing methods provide an appropriate solution for a complete availability of all network participants.

However, situations are also possible, in which one or a small number of radio nodes must be connected to a central radio station over a long distance. A further scenario, which represents a mid-point between the extremes mentioned, is provided by networks with relatively-low density and average radio distances. Transitional forms between these scenarios will also be possible, for example, islands of partial networks with relatively shorter radio distances, which are supposed to maintain a connection with other partial networks with similar parameters over relatively longer distances.

If radio devices are operated with fast transmission speeds, the resulting bandwidth required leads to considerably restricted radio ranges. In mobile use, if a network participant moves to a distance outside the radio range of the other network participants, it will be excluded from communication. Since the network participants use a common waveform, which is based upon a defined bandwidth, the “excluded” network participant cannot generally restore the radio connection by unilateral means. It is necessary for the radio systems to have implemented corresponding mechanisms in such cases.

Radio-transmission systems according to DE 10 2005 030 108 A1 are specially adapted for high-mobility, flexible use in different scenarios. Radio systems conceived in this manner are characterized by a highly-developed adaptability, which allows the system to adapt to radio channels with extremely varied channel qualities. However, DE 10 2005 030 108 A1 does not describe how the radio systems achieve the object of maintaining the required radio connections and measuring the channel quality.

The present invention is based upon the object of providing a radio-transmission system and a corresponding method of operation, with which radio devices can establish or maintain radio connections with their remote stations, which are required to communicate messages via one or more radio node.

This object is achieved by a radio-transmission system according to claim 1 and a method for operating a radio-transmission system according to claim 13. The dependent claims specify advantageous further developments of the invention.

An exemplary embodiment of the invention is described below with reference to the drawings. The drawings are as follows:

FIG. 1 shows an example of a digital battlefield network;

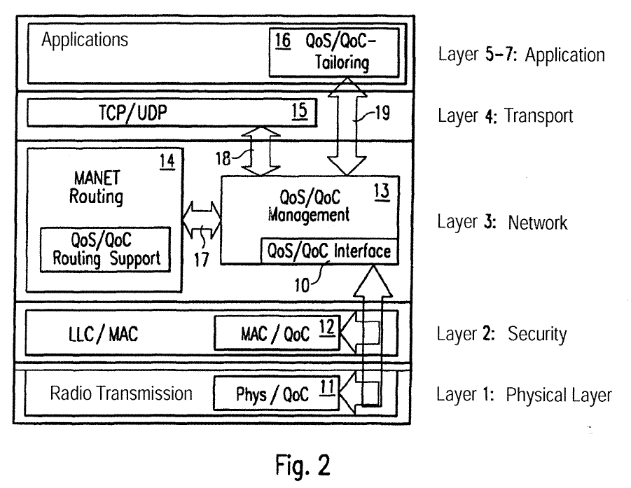

FIG. 2 shows a block-circuit diagram of a layer-structure of the radio-transmission system for use within the framework of the invention;

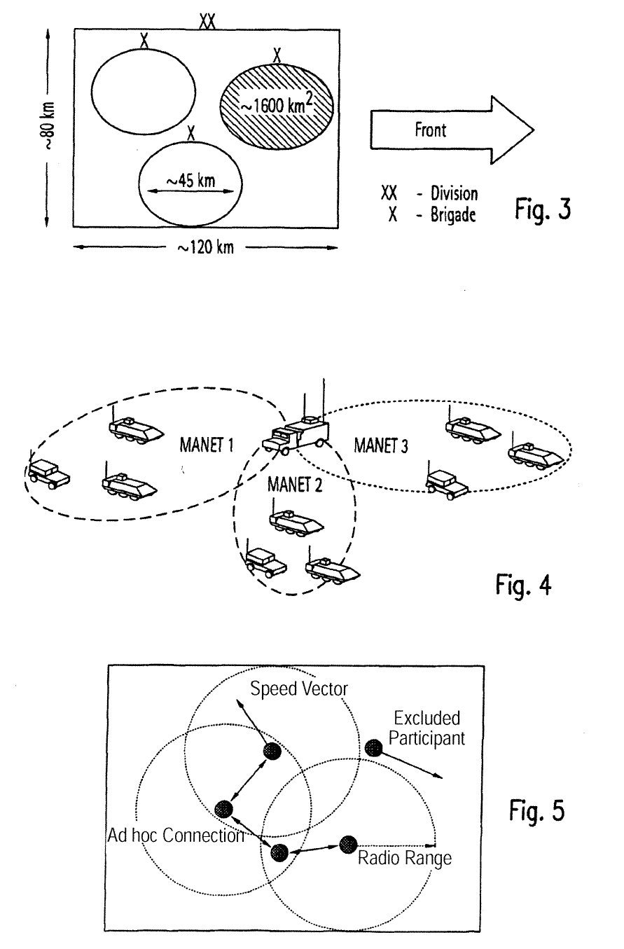

FIG. 3 shows the anticipated operational and mobility areas;

FIG. 4 shows homogenous MANETs with short distance variants;

FIG. 5 shows the overstretching of radio distances in MANETs;

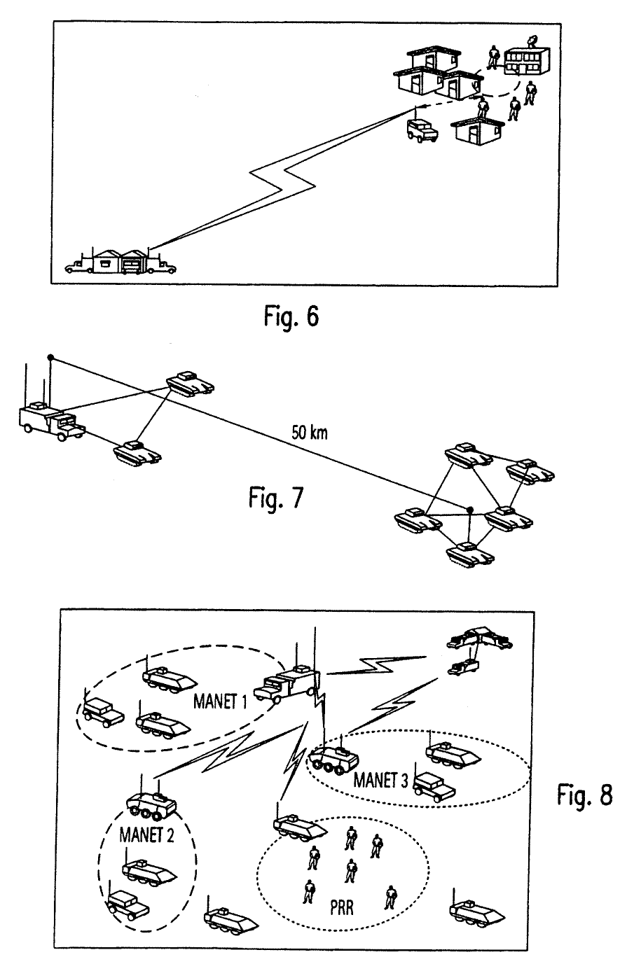

FIG. 6 shows the scenario of house-to-house fighting;

FIG. 7 shows a long-distance connection;

FIG. 8 shows transitional forms of highly-dynamic scenarios; and

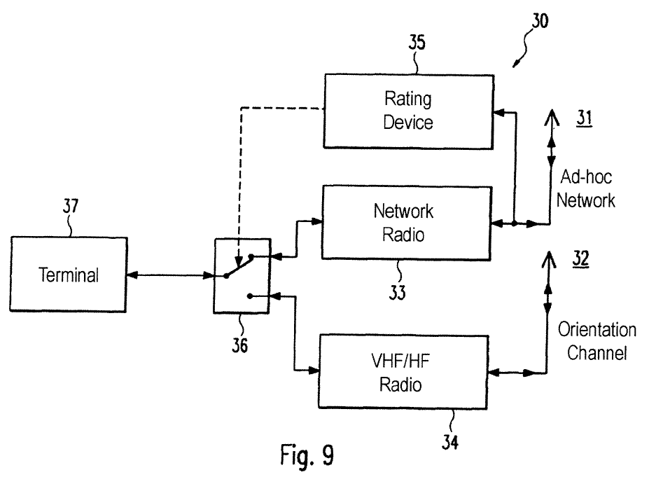

FIG. 9 shows an exemplary embodiment of the configuration of a mode of the radio-transmission system according to the invention.

With regard to the problem of the time-variant quality and capacity of radio channels, DE 10 2005 030 108 A1 proposes a package consisting of three solutions:
optimisation of the quality and capacity of the individual radio links;
adapted and optimized routing;
selection of appropriate applications and/or adaptation of applications.

For this purpose, the approach according to DE 10 2005 030 108 A1 provides a subdivision of tasks between the divisions of classical radio technology (layers 1 and 2 of the ISO/OSI layer model) and network technology (layer 3 and above) with a co-operation between the two divisions, as illustrated in FIG. 2. An interface 10, across which the quality features and optionally control data can be exchanged, is provided between these divisions, wherein the control data are generated as a response to the quality features exchanged.

Below the interface 10, that is to say, in the classical radio division, in block 11 of layer 1, steps (phys/QoC) must be taken to analyse the radio channel, to establish corresponding quality features, and to match the radio channels to the respective topographical situation through adaptive measures.

In the following section, with reference to the quality of service defined for the network (QoS), the relevant quality features are described as the Quality of Channel (QoC). They are processed in the functional block 11 (phys/QoC).

Additional functions (MAC/QoC) must be provided for the control of channel access (e.g. Link Management, Slot Multiplexing) and data flow dependent upon the current channel quality and the priority of the packets and their requirements with regard to channel quality (Class of Service, CoS). This is implemented in functional blocks 12 (MAC/QoC) of layer 2. The priority of the packets can be established either in a service-specific and/or user-specific manner. This is also implemented in functional block 12 (MAC/QoC).

Above the QoC—QoS interface 10, that is to say, in the network division, means must be found to adapt the communication to the properties of the channels to be used with the assistance of these QoC values.

The following measures, for example, must be adopted in functional block 13 of layer 3 (QoC/QoS—Management):
sorting the data packets according to priority (MAC/QoC)
adapted queuing (MAC-QoC), that is to say, formation of queues dependent upon priority;
support of the MANET functions (QoS/QoC Routing Support), for example, through:
range calculation using digitised cards
connection analysis using exchanged position coordinates
connection prognoses using velocity vectors of the objects containing radio stations
determination of the quality features for the individual links through the radio devices
marking of path qualities in the routing tables
conversion of the QoC values into the QoS values and adaptation to IP functionality (matching to TCP/UDP)
notification of the user regarding the available channel quality and capacity (QoS/QoC Tailoring) and display of available services
adaptation of applications to the available channel quality and capacity (QoS/QoC Tailoring)
reactions and measures regarding the channel capacity, for example, prioritisation, data reduction or interruption, which is implemented at the level of the application in functional block 16 (QoS/QoC Tailoring).

In order to coordinate the measures above and below the interface 10, the QoC and QoS parameters must be mapped onto one another. This is also necessary in order to achieve a smooth transition between radio networks and wire-bound networks, that is to say, so that the service features (QoS mechanisms) defined for the wire-bound networks are also implemented in radio networks.

The channel access (Medium Access, MAC); the MANET routing in functional block 14 of layer 3; the transport protocols TCP/UDP, in which the data in functional block 15 of layer 4 are converted; and the applications in layers 5 to 7 are all affected. Accordingly, the QoC/QoS mapping must be expanded by means of additional functions. This is implemented in a functional block 13 (QoC/QoS—Management). For this purpose, functional block 13 is connected via further interfaces 17, 18 and 19 to functional blocks 14, 15 and 16.

The function of the radio-transmission system illustrated in FIG. 2 can therefore be explained as follows:

The radio-transmission system has several processing layers for the transfer of data packets between various radio devices in a radio channel and comprises several functional units and one control unit. A first functional unit 11 is localised in a physical radio-transmission layer and analyses the radio channel in order to determine the quality of the radio channel QoC.

A second functional unit 12 is localised in a data-security layer and controls access to the radio channel, dependent upon the current quality of the radio channel QoC, and controls the priority of the data packets to be transmitted dependent upon the quality QoS of the service realized by the data packets. A third functional unit 14 is localised in a network layer and controls the routing of the data packets.

A superordinate control unit 13 releases the data packets for routing through the third functional unit 14 only if the quality of the service QoS realized by the data packets corresponds adequately with the quality of the radio channel QoC specified in the first functional unit 11, that is to say, if a minimum quality of the radio channel QoC is present for the quality of the service or respectively service feature QoS of the application.

The control unit 13 is connected to the first functional unit 11 and to the second functional unit 12 via a first interface 10 and to the third functional unit 14 via a second interface 17.

Furthermore, the control unit 13 is preferably connected via a third interface 18 to a fourth functional unit 15 in a transport layer. The fourth functional unit 15 converts the data packets into a corresponding transport protocol, for example, TCP/UDP.

The control unit 13 specifies the corresponding transport protocol TCP/UDP on the basis of the quality of the service realized by the data packets QoS and the quality of the radio channel QoC specified in the first functional unit 11 and controls the fourth functional unit accordingly.

The control unit 13 is preferably connected via a fourth interface 19 to a fifth functional unit 16 in an application layer. If the data packets for routing through the third functional unit 14 cannot be released, a corresponding notification is preferably sent to the user from the fifth functional unit 16.

In this context, the control unit 13 controls the third functional unit 14 in such a manner that it ensures through appropriate routing the availability of the transmission capacity of the radio channel necessary for the respective quality of the service QoS realized by the data packets.

The control unit 13 preferably sorts the data packets dependent upon the priority required by the quality QoS of the service realized respectively by the data packets. Following this, the third functional unit is controlled to implement the routing of the data packets in this sequence.

The control unit 13 can also implement a prognosis of the quality of the radio channel developing in future on the basis of determined velocity vectors of the moving radio devices.

In summary, according to the solution of DE 10 2005 030 108 A1, the continuous determination of possible paths (radio paths) of the network (MANET), which is required in mobile use, is supported by intelligent procedures. The radio channels are matched by adaptive measures to the respective topographical situation, and the respective channel capacity and quality of the individual radio paths are recorded and taken into consideration in the transport of the data packets.

However, with this approach of DE 10 2005 030 108 A1, radio connections can be maintained only over limited radio distances. In scenarios, in which larger radio distances must be bridged, additional measures are required. These measures will be described below.

The range of radio systems in ground-to-ground connections is determined by the following parameters. It is shorter, the higher the useful frequency is. It is shorter, the faster the data rate or the broader the useful bandwidth in each case, or the higher the value of the modulation type used. It is longer, the greater the transmission power. It is longer, the higher the antenna gain. It is longer, the higher the antenna base.

In stationary operating mode, the three last radio parameters, namely the antenna height, the antenna gain and the transmission power can be increased in order to bridge longer radio distances. In mobile operations, this is either impossible or possible only to a very limited extent without the technically and operationally very questionable use of airborne relay stations such as un-manned aircraft, balloons, helicopters etc. For this reason, a solution must be found for mobile operations, which also allows radio systems with simple and low antennas and a low transmission power, for example, man packs, to determine the change of channel quality and to respond to the overstretching of radio distances.

The channel quality can be tracked continuously by analyzing the radio channel used. This analysis can be implemented both in a channel without radio traffic and also in an occupied channel. In the first case, the magnitude and type of interference signals can be determined and recorded; in the second case, the message signals are analyzed. Since known technical parameters such as the modulation type, data rate etc. are involved, the analysis of the channel can be implemented in a very detailed manner with regard to quality criteria such as signal-noise ratio, fading parameters, bit-error rate and so on. Since a radio node will generally receive signals from several remote stations, these quality features can be allocated to the individual radio distances within the combined network.

With this method, for example, using the signal field strength, inferences can be drawn regarding the distance of the remote station. If the coordinates of the sites of the radio nodes are also exchanged during network operation, the distances can be calculated and the availability and the associated, necessary radio parameters can be determined by means of terrain maps and propagation models.

Modern broadband radio devices will use data rates up to a few Mbits/s and therefore bandwidths of several MHz. For several reasons, this transmission will be implemented in relatively-higher frequency ranges, for example, within the range of a few hundred MHz or up the GHz range. However, the radio distance, which can be bridged in this manner, is quite short. Under unfavorable conditions, it may be limited to a few hundred meters. Requirements for bridging a range of a few tens of kilometers in this frequency band can also be achieved only with very narrow user bandwidths by relay stations located at a high altitude.

If the channel quality changes, it is possible to react to such changes on the basis of the given analysis results through an adaptation of the radio parameters, for example, by adapting the signal bandwidth and the associated data rate or by a change of modulation type or coding. As a result of distributing the channel information within the network, every radio node can select the radio parameters optimum for communication with a partner, in particular, if the positions of the radio nodes are additionally known by exchanging coordinates.

However, these methods are unsuccessful, if the adaptability of the waveform used at the selected (relatively-higher) user frequency to the current radio distance is exhausted. In this case, as illustrated above, the user frequency and bandwidth must be considerably lower. With conventional, tactical radio methods, for example, with a useful bandwidth of 25 kHz in the VHF range from 30-88 MHz and dependent upon the terrain, radio ranges up to a few tens of kilometers can be bridged. The use of the HF range with bandwidths of, for example, 3 kHz, which are conventional in that context, allows even longer radio ranges.

If the radio node is disposed at a current radio distance, which can longer be bridged with the waveform used even after adaptation, as a last resort, according to the invention, there remains only a use of a narrow-band method in a relatively lower frequency range, that is to say, a use according to the invention of a so-called orientation channel. The bandwidth and frequency range of this method are orientated according to the maximum-expected radio distances in the respective usage scenarios. Since the time of the overstretching of the radio distances cannot be predicted a priori, the radio nodes should preferably be continuously ready to receive signals of this kind. As an alternative, if the channel quality is known, this orientation channel could be allocated by negotiation within the network to that radio node, which will, with a high probability, no longer be available. Communication with this node within the network will then be implemented via this channel; the no-longer-available node will then communicate via this orientation channel. Accordingly, the radio nodes must be ready to receive the orientation channel only in the event that one or more radio nodes are no longer available using the transmission method with a fast data rate in the ad-hoc network.

This readiness to receive can be realized in different ways. Possible solutions include the following: cyclical switching of the radio node to receive an orientation signal and/or use of a separate receiver to receive an orientation signal and/or use of an integrated software-guard receiver to receive an orientation signal and/or use of an integrated hardware-guard receiver to receive an orientation signal.

This orientation signal is designed in such a manner that it can bridge the maximum range for the scenarios expected. If it is used, the station receiving the orientation signal can determine channel properties using the method described above for the analysis of a useful signal and, by extrapolation from this, can determine the maximum useful bandwidth present for the radio distance.

The advantage of the present invention is that it can cover all radio ranges using adaptive radio devices, provided that this is physically possible.

For this purpose, the continuous analysis of the useful channel, as mentioned above, for example, by analysis of channel without radio traffic with a determination and recording of the magnitude and type of interference signals and/or by analysis of the message signals of an occupied channel with an analysis of the constellation diagram and/or an analysis of the signal-noise ratio and/or an analysis of fading parameters and/or an analysis of the bit-error rate and allocation of the analysis results to the individual radio distances in the combined network.

The method for maintaining radio connections by means of continuous analysis of the radio channel and distribution of the channel parameters within the radio network is used for adaptive adjustment of the waveform (for example, modulation type, type of coding, signal bandwidth, transmission power and antenna directional effect).

The method for manufacturing and maintaining radio connections by means of a narrow-band, robust orientation channel is used in the event that normal communication via the adaptive standard waveform is no longer possible, because the channel parameters have deteriorated, and also for recording the communication of a participant within a network in the case of unknown channel parameters.

In particular, the properties of the orientation channel are as follows: low-frequency, narrow bandwidth, robust modulation method and coding, and optionally a relatively-high transmission power by comparison with the actual useful channel.

The illustration in FIG. 1 serves to visualize future radio networking. However, it represents an obvious simplification and only inadequately describes the circumstances encountered in practice. The conditions illustrated, that is to say: a particularly clear and simple overview of the terrain is provided; the radio distances are extremely short; the density of radio nodes is high; stationary units with high antennas are present and airborne relay stations are available, do not adequately describe real situations and potential performance features of modern radio systems. In practice, especially in the case of an advance of troops or in mobile battle action, large areas, which must be covered by radio, are involved.

FIG. 3 shows the operational and mobility areas anticipated within the divisional and brigade framework. The distribution of radio nodes in these areas can in no sense always be expected to be quasi homogeneous with short radio distances. Islands of radio networks with relatively-long distances between these islands are frequently formed. The dynamic, mobile and flexible operational possibilities are reflected in a plurality of potential scenarios, in which the radio systems are supposed to allow secure communication. The framework for this diversity of scenarios will now be presented with a few representative examples.

As shown in FIG. 4, scenarios exist, which provide a relatively-high density of mutually-communicating radio devices at short distances from one another. Adapted mobile ad-hoc networks with suitable routing methods provide an appropriate solution for homogenous radio networks of this kind.

In mobile use, there are necessarily situations, in which relatively long distances between stations and their MANETs or between MANETs occur, which can no longer be bridged with the radio range of a broadband waveform.

If, as illustrated in FIG. 5, a network participant moves out of the radio range of the other network participants, it will be excluded from communication. If the network participants are using a common, non-adaptive waveform, which is based on a defined bandwidth, the “excluded” network participant cannot generally restore the radio connection by unilateral means.

However, situations are also possible, in which one or a small number of radio nodes have to be connected to a central radio station over a long distance or in a terrain with unfavorable propagation conditions.

As illustrated in FIG. 6, this situation is found, for example, in house-to-house fighting, with reconnaissance troops or patrols. Especially in the latter case, with excursions through the terrain to be controlled, long distances from the central radio station, for example, the company battle station, are possible, as illustrated in FIG. 7. However, in such cases, it is also necessary for the patrol to have or to establish a radio connection with the base station. Special measures become necessary in the case of excursions through difficult terrain, for example, in mountainous terrain or over distances, which significantly exceed the range of approximately 20 kilometers, which can be covered conventionally with tactical radio.

Transitional forms are also possible between these scenarios, for example, islands of partial networks with short radio distances, which must maintain contact over relatively-long distances with other partial networks with similar parameters.

FIG. 8 illustrates potential mixed forms of scenarios. There is a connection in the partial networks (MANET 1, 2, 3, PRR; Personal Role Radio); however, they are spatially separated to such an extent that the connection between the partial networks is no longer possible with the waveform used in the MANETs. The two vehicles outside the MANETs can no longer be reached from the partial networks because of the great distance.

FIG. 9 shows a node 30 of the radio-transmission system according to the invention. The radio-transmission system comprises the ad-hoc network 31 described above and an orientation channel 32, wherein each node 30 is connected both to the ad-hoc network 31 and also to the orientation channel 32.

In the exemplary embodiment presented in FIG. 9, a network radio device 33 is provided for communication via the ad-hoc network, and a VHS (Very High Frequency range, 30 MHz to 88 MHz) and/or an HF radio device (for the high-frequency range, 10 MHz to 30 MHz) is provided for communication via the orientation channel 32. Communication is implemented on the channels of the ad-hoc network 31, which are disposed, for example, in the SHF range of a few GHz via the network radio device 33, while communication is implemented on the orientation channel 32, which is preferably disposed in the HF range, that is to say, the short-wave range or respectively the VHF range, via the VHF/HF radio device. If the orientation channel 32 is disposed at a lower frequency by comparison with the ad-hoc network 31, this generally leads to a longer range, so that radio nodes, which can no longer be reached via the ad-hoc network 31, can still communicate via the orientation channel 32.

It is not absolutely necessary that the network radio device 33 and the radio device 34 for the orientation channel are separated from one another. On the contrary, the radio device 34 for the orientation channel can also be integrated in the network radio device 33 as a hardware component or a software component. Furthermore, it is possible for the network radio device to be switched simply through commands in the frequency range of the orientation channel. In this case, the radio device also processes the orientation channel. With this design, the orientation channel can be operated only in alternation with the useful channel.

An evaluation device 35 constantly evaluates the quality of the transmission of the data packets via the ad-hoc network 31. If the transmission via the ad-hoc network 31 is no longer satisfactory, a switching device 36 is switched over in such a manner that the terminal device 37 no longer communicates via the network radio device 33, but via the radio device 34 for the orientation channel. The evaluation of the quality of the data packets, which can be transmitted on the ad-hoc network 31, can be implemented in a variety of ways. For example, as already mentioned, an analysis of the constellation diagram and/or the signal-noise ratio and/or of fading parameters and/or of the bit-error rate can be implemented.

The evaluation device 35 evaluates a channel of the ad-hoc network 31 not occupied with radio traffic in a meaningful manner by determining the magnitude and/or type of the interference signals on this channel. By contrast, a channel of the ad-hoc network 31 occupied with radio traffic is meaningfully evaluated by the evaluation device 35 by analyzing the message signals of the data packets transmitted on this channel.

It is also meaningful, if the switching device 36 is operated in such a manner that the system also switches cyclically to the orientation channel 32 whenever the evaluation device 35 evaluates the transmission via the ad-hoc network 31 as qualitatively adequate. This has the advantage that, during the cyclical switchover to the orientation channel 32, radio nodes 30 of the network can determine whether another node is transmitting there, which can longer be reached via the ad-hoc network 31. A node 30 of this kind, which determines during the cyclical switchover that it can communicate with the other node via the orientation channel 32 can then once again feed the data of this node, which is isolated from the ad-hoc network 31, into the ad-hoc network 31, thereby maintaining communication with the isolated node.

It is meaningful, if communication is implemented via the orientation channel 32 with a robust, that is to say, generally lower-value modulation type, for example, low-value PSK (Phase Shift keying) or FSK (Frequency Shift Keying), by comparison with the ad-hoc network 31. It is also meaningful, if an improved error protection is used for communication via the orientation channel 32, which then determines a relatively-slower useful data rate than is used for communication via the ad-hoc network 31. A slower data rate should also be used for communication via the orientation channel 32 than for communication via the ad-hoc network 31. For communication via the orientation channel, a higher transmission power than for communication via the ad-hoc network 31 can optionally also be used.

The orientation channel can additionally be used in order to request the identity and position of radio nodes potentially capable of being integrated into the MANET. For this purpose, the requesting radio node can transmit a corresponding message to the orientation channel either singly, for example, with initiation by the user, or in a cyclical manner, for example, every second. A receiving radio node can then respond to this message in the orientation channel. Accordingly, it is also possible to identify radio devices, which do not have the MANET functionality at their disposal, but which receive the orientation channel and can then transmit on this channel again. The use of the orientation channel for this purpose is particularly advantageous, because, as already mentioned, it provides a relatively-longer range and accordingly, the MANET can also obtain information about radio devices disposed outside its range. This knowledge can be used, for example for friend-foe recognition.

The invention is not restricted to the exemplary embodiment presented. The orientation channel can optionally also be a given channel of the ad-hoc network, which is equipped as a general hailing channel. All of the features described above can be combined with one another as required within the framework of the invention.

1. Radio-transmission system comprising
an ad-hoc network with several nodes, across which data packets are transmitted with a predetermined waveform,
an evaluation device for every node, which evaluates the quality of the transmission of the data packets via the ad-hoc network, and
an orientation channel, across which the data packets are transmitted, if the evaluation device has evaluated the quality of transmission of the data packets via the ad-hoc network as unsatisfactory,
wherein
every node of the radio-transmission system provides a switching device, which also switches the reception in a cyclical manner between a frequency of the ad-hoc network and the frequency of the orientation channel, if the evaluation device has evaluated the transmission via the ad-hoc network as qualitatively satisfactory.

2. Radio-transmission system according to claim 1,
wherein
the orientation channel has a relatively-lower transmission frequency, in comparison with the ad-hoc network.

3. Radio-transmission system according to claim 1,
wherein
the orientation channel provides a relatively more robust modulation type, in comparison with the ad-hoc network.

4. Radio-transmission system according to
claim 1, wherein
the orientation channel provides a relatively lower-value coding by in comparison with the ad-hoc network.

5. Radio-transmission system according to
claim 1, wherein
the orientation channel provides at least one of an improved error protection and a better coding in comparison with the ad-hoc network.

6. Radio-transmission system according to
claim 1, wherein
the orientation channel provides a relatively higher transmission power in comparison with the ad-hoc network.

7. Radio-transmission system according to
claim 1, wherein
the evaluation device evaluates a channel of the ad-hoc network which is not occupied with radio traffic, by determining at least one of the magnitude and the type of interference signals on the channel.

8. Radio-transmission system according to
claim 1, wherein
the evaluation device evaluates a channel of the ad-hoc network which is occupied with radio traffic, by analyzing the message signals of the data packets transmitted on the channel.

9. Radio-transmission system according to claim 8,
wherein
the evaluation device implements an analysis of at least one of a constellation diagram, a signal-noise ratio, fading parameters, and a bit-error rate.

10. Radio-transmission system according to
claim 1, comprising
a network radio device for at least one of transmission on the orientation channel and reception of the orientation channel.

11. Radio-transmission system according to
claim 1, wherein
every node of the radio-transmission system provides a separate transmitter-receiver for the reception of the orientation channel.

12. Radio-transmission system according to
claim 1, wherein
every node of the radio-transmission system provides a hardware module or software module for the reception of the orientation channel, which is integrated in a network radio device associated with the respective node.

13. Method for operating a radio-transmission system comprising an ad-hoc network, across which data packets are transmitted with a predetermined waveform, and
said system comprising an orientation channel, said method comprising:
constantly evaluating the quality of the transmission of the data packets via the ad-hoc network, and transmitting the data packets via the orientation channel, if the quality of the transmission of the data packets via the ad-hoc network is evaluated as unsatisfactory,
and
in every node of the radio-transmission system, also switching the reception in a cyclical manner between a frequency of the ad-hoc network and a frequency of the orientation channel, if the evaluation device has evaluated the transmission via the ad-hoc network as qualitatively satisfactory.

14. Method according to claim 13,
comprising operating
the orientation channel with a relatively-lower transmission frequency in comparison with the ad-hoc network.

15. Method according to claim 13,
comprising operating
the orientation channel with a relatively lower-value modulation type in comparison with the ad-hoc network.

16. Method according to
claim 13, comprising operating
the orientation channel with an improved error protection in comparison with the ad-hoc network.

17. Method according to
claim 13, comprising operating
the orientation channel with a relatively slower data rate in comparison with the ad-hoc network.

18. Method according to
claim 13, comprising operating
the orientation channel with a relatively higher transmission power by comparison with the ad-hoc network.

19. Method according to
claim 13, comprising constantly evaluting
a channel of the ad-hoc network which is not occupied with radio traffic, by determining at least one of the magnitude and type of interference signals on the channel.

20. Method according to
claim 13, comprising evaluating
a channel of the ad-hoc network which is occupied with radio traffic, by analyzing the message signals of the data packets transmitted on the channel.

21. Method according to claim 20,
comprising analyzing at least one of a constellation diagram, a signal-noise, fading parameters, and a bit-error rate.

22. Method according to
claim 13, comprising using
the orientation channel for requesting the identity of a network node and for requesting its position.

23. Method according to claim 22,
comprising implementing
said request either singly, with initiation by the user, or in a cyclical manner, controlled by the node.

24. Radio-transmission system according to claim 2, wherein the orientation channel has a transmission frequency within the HF range (10 MHz to 30 MHz).

25. Radio-transmission system according to claim 2, wherein the orientation channel has a transmission frequency within the VHF range (30 MHz to 88 MHz).

26. Radio-transmission system according to claim 3, wherein the modulation type provided by the orientation channel is a relatively lower-value PSK (Phase Shift Keying) or FSK (Frequency Shift Keying) modulation type.

27. Method according to claim 14, comprising operating the orientation channel with a transmission frequency within the HF range (10 MHz to 30 MHz).

28. Method according to claim 14, comprising operating the orientation channel within the VHF range (30 MHz to 88 MHz).

29. Method according to claim 15, comprising operating the orientation channel with a PSK (Phase Shift Keying) or FSK (Frequency Shift Keying) modulation type.
